(19) United States
(12) Patent Application Publication
(10) Pub. No.: US 2009/0240759 A1
(43) Pub. Date: Sep. 24, 2009

(54) Methods and Apparatus for Web Application Testing Using Proxy

(76) Inventors: Takashi Miyamoto, Tokyo (JP); Kohsuke Okamoto, Sagamihara-shi (JP)

Correspondence Address: RYAN, MASON & LEWIS, LLP, 90 FOREST AVENUE, LOCUST VALLEY, NY, 11560, US

(21) Appl. No.: 12/051,372

(22) Filed: Mar. 19, 2008

(51) Int. Cl. G06F 15/16

(52) U.S. Cl. 709/201

(57) ABSTRACT

Techniques for testing at least one application using at least one proxy are provided. At least one request directed to a running application is obtained from a client. The at least one request is forwarded to the running application and at least one test application. At least one response from the running application and at least one response from the at least one test application are recorded. The at least one response from the at least one test application is compared to the at least one response from the running application. The comparison is used to evaluate performance of the at least one test application.

### FIELD OF THE INVENTION

The present invention relates to application development tools and, more particularly, to techniques for testing new applications.

### BACKGROUND OF THE INVENTION

As a result of increased technological innovation and increased competition between software developers, it is common for computer applications to undergo constant upgrades. However, upgrades are not easily implemented. Upgrading an application requires an incredible amount of preparation. For instance, a developer interested in upgrading an already running application (e.g., web application) must test the upgrade before implementing it. Ideally, a developer would want to test the upgrade in a real-world environment. However, in many cases this requires replacing a currently running/operational application with an untested, experimental upgrade, which is never recommended. The alternative is to simulate realistic operations to determine if the upgrade is operating properly. This, as many know, is not an easy task.

Conventional techniques require that a developer create test cases which simulate various operations. This is difficult and time consuming because the developer must be knowledgeable enough to understand how to run the tests and know what results to expect. In addition to being time consuming, this technique falls short of a realistic operating environment. For example, many complex web applications require customers to login and interact with real, existing accounts. Realistically, a customer would not want developers to run test cases on their account especially if the account is related to sensitive material (e.g., finances). Furthermore, in practice, the test cases must include sensitive login and password information in order to carry out the operations of the test case, which presents a security issue. Developers can use “dummy” account information in lieu of real account information, however, dummy accounts are unrealistic and artificial.

Another issue with the use of test cases is the inability to compare the performance of an upgrade to the performance of a currently running application. The only way to compare performance results is to run test cases on both the running application and the test application (e.g., upgrade). Testing a currently running application may involve interrupting its normal operation. In practice, a developer would not want to do this. Shutting down a currently running application for tests is costly and may negatively impact application users.

Therefore, there is a need for techniques that allow developers to test new applications, wherein the developer can: (1) analyze test applications in a real-world environment, making the generation of test cases unnecessary; (2) test applications without interrupting a currently running application; and (3) accurately compare the performance of the test applications to the performance of the currently running application with minimal effort and without compromising security.

### SUMMARY OF THE INVENTION

Principles of the present invention provide techniques that overcome the above-mentioned drawbacks associated with existing methods by providing techniques that address the above needs, as well as other needs. More particularly, principles of the invention suggest the utilization of one or more proxy to test one or more new applications. By using proxy, a developer can test new applications while a current application continues to run.

In accordance with one aspect of the invention, a technique for testing at least one application using at least one proxy is provided. At least one request directed to a running application from a client is obtained. The at least one request is forwarded to the running application and at least one test application. At least one response from the running application and at least one response from the at least one test application are recorded. The at least one response from the at least one test application is compared to the at least one response from the running application to evaluate performance of the at least one test application. The client may be a user or a server. Further, the running application may be a web application. Still further, the at least one response from the running application may be forwarded to the client.

In an alternative embodiment of the present invention, the step of recording may be in accordance with a recording policy, a client identification, a uniform resource locator, a content of the at least one response from the running application, a content of the at least one response from the at least one test application, an instruction from another proxy, and/or a relation criteria. Further, the client identification may be an internet protocol address, a hypertext transfer protocol session identification, and/or an authentication.

In an additional embodiment, the step of comparing further comprises the steps of setting a time frame in reference to the at least one response from the running application and searching, within the time frame, for the at least one response from the at least one test application corresponding to the at least one response from the running application. The step of searching may be in accordance with a matching policy. The matching policy may determine if the at least one response from the at least one test application corresponds to the at least one response from the running application.

Further still, at least one request from the running application and at least one request from the at least one test application, directed to a server, may be recorded. The at least one request from the at least one test application may be compared to the at least one request from the running application to evaluate performance of the at least one test application.

In a second aspect of the present invention, an article of manufacture for testing at least one application using at least one proxy comprises a computer readable storage medium identified by one or more programs, which when executed by a computer implement the above steps.

In a third aspect of the invention, an apparatus for testing at least one application using at least one proxy comprises: a memory; and at least one processor coupled to the memory and operative to: (i) obtain at least one request directed to a running application from a client; (ii) forward the at least one request to the running application and at least one test application; (iii) record at least one response from the running application and at least one response from the at least one test application; and (iv) compare the at least one response from the at least one test application to the at least one response from the running application to evaluate performance of the at least one test application.

In accordance with a fourth aspect of the present invention, a system for testing at least one application using at least one proxy is provided. The system comprises: a first server; at least one second server connected to the first server via a communications network; and at least one processor operatively coupled to the first server, the processor being operative to: (i) obtain at least one request directed to a running application from a server; (ii) forward the at least one request to the running application and at least one test application; (iii) record at least one response from the running application and at least one response from the at least one test application; and (iv) compare the at least one response from the at least one test application to the at least one response from the running application to evaluate performance of the at least one test application.

In accordance with a fifth aspect of the present invention, a system for testing at least one application using at least one proxy is presented. The system comprises: a first server; a first proxy connected to the first server via a communications network; at least one second server connected to the first proxy via a communications network; a second proxy connected to the at least one second server via a communications network; and a third server connected to the second proxy via a communications network. The first and second proxy are operative to: (i) obtain at least one request directed to a running application from a server; (ii) forward the at least one request to the running application and at least one test application; (iii) record at least one response from the running application and at least one response from the at least one test application; and (iv) compare the at least one response from the at least one test application to the at least one response from the running application to evaluate performance of the at least one test application.

These and other objects, features, and advantages of the present invention will become apparent from the following detailed description of illustrative embodiments thereof, which is to be read in connection with the accompanying drawings.

### BRIEF DESCRIPTION OF THE DRAWINGS

FIG. 1 is a flow diagram illustrating a methodology for testing at least one application using at least one proxy, according to an embodiment of the present invention.

FIG. 2 is a diagram illustrating a system for testing applications using one proxy, in accordance with an embodiment of the present invention.

FIG. 3 is a diagram illustrating a system for testing applications using two proxy, in accordance with an additional embodiment of the present invention.

FIG. 4 is a system diagram illustrating the components of a proxy, in accordance with one embodiment of the present invention.

FIG. 5 is a diagram illustrating an illustrative hardware implementation of a computing system in accordance with which one or more components/methodologies of the present invention may be implemented, according to an embodiment of the present invention.

### DETAILED DESCRIPTION OF PREFERRED EMBODIMENTS

The present invention will be described in conjunction with exemplary methods for testing applications on a networked environment using proxy. It should be understood, however, that the invention is not limited to the particular embodiments described herein. The principles of this invention are generally applicable to any application and testing environment, and modifications to the illustrative embodiments will become apparent to those skilled in the art given the teachings described herein.

The term “application” as used herein is intended to be construed broadly so as to encompass, by way of example and without limitation, a computer-based program or group of computer-based programs designed for users.

The term “client” as used herein is intended to be construed broadly so as to encompass, by way of example and without limitation, a computer-based device capable of accessing another computer-based device via a communications network.

The term “server” as used herein is intended to be construed broadly so as to encompass, by way of example and without limitation, a computer-based device capable of managing network resources. A server may contain multiple applications.

The term “proxy” as used herein is intended to be construed broadly so as to encompass, by way of example and without limitation, a computer-based device capable of intercepting and forwarding requests to clients and servers.

The term “response” as used herein is intended to be construed broadly so as to encompass, by way of example and without limitation, an answer in reply to an instruction or command.

The term “request” as used herein is intended to be construed broadly so as to encompass, by way of example and without limitation, a command or instruction to be processed by a computer-based device.

The term “web application” as used herein is intended to be construed broadly so as to encompass, by way of example and without limitation, an application that functions in a networked environment (e.g., internet, the world wide web).

Key challenges in testing new applications in networked environments are: (1) being able to test applications in a real working environment without the need for test cases; (2) having the ability to test applications without interrupting a currently existing and running application; and (3) having the capability to accurately compare the performance of the test applications to the performance of the existing application with minimal effort and without compromising security. Conventional techniques require developers to test new applications in an unrealistic environment through the use of pre-generated test cases. Test cases only simulate and never duplicate a real interactive environment in which an application was meant to operate. Further, in order to simulate a real-world environment, test cases may require sensitive access information (e.g., usernames and passwords), which presents a security issue. In addition, in order to evaluate performance, a developer must individually apply test cases to the test application and the currently running application. This may require interrupting the operation of the currently running application. Interruptions can be costly to both service providers and customers who rely on the running application to conduct business.

Referring initially to FIG. 1, a flow diagram illustrates a methodology 100 for testing at least one application using at least one proxy, according to an embodiment of the present invention. In an illustrative embodiment, methodology 100 is carried out by a proxy server. The proxy server may be connected to: (1) a web browser client, (2) a currently running application located on a remote server, and (3) test applications located on one or more remote servers. Methodology 100 begins at step 102 where one or more requests directed to a currently running application are obtained. At step 104, the requests are forwarded to the currently running application and one or more test applications. The forwarded requests are processed by the running application and one or more test applications, and responses are returned.

At step 106, responses from the currently running application and the test applications are recorded. In an illustrative embodiment, responses from the running application and the test application are selectively recorded. The recording of responses may be in accordance with (1) a recording policy, (2) a client identification, (3) a uniform resource locator (URL), (4) content of the response from the running application, (5) content of the responses from the test applications, (6) an instruction from another proxy (in situations when more than one proxy is used), and (7) a relation criteria. These features may be defined by an application developer/tester.

In an exemplary embodiment, the recording policy may be an instruction to the proxy to ignore particular data. For example, any request data containing user identification or password information may be overlooked for recording purposes. This policy would eliminate security issues inherent in pre-generated test cases, which usually require the incorporation of user identification and password information in order to function.

In an additional embodiment, responses may be recorded according to client identification. Client identification may include a client internet protocol (IP) address, a hypertext transfer protocol (HTTP) session identification, or a basic authentication (e.g., username). The client identification allows a developer to focus testing sessions on a particular client or group of clients. This is practical when a large number of users/clients access a running application at the same time. A specified uniform resource locator (URL) may also be used to identify a particular client of interest.

Recording may also be regulated by flagging content contained in the responses from the running application and the test applications. For example, an error response or no response from a test application may signal an end to recording. Further, a developer may flag responses regarding a specific operation. For instance, when testing a banking application, a developer may want to record responses regarding deposits and not withdrawals. In an additional embodiment, a developer may want to record responses with specific code or data.

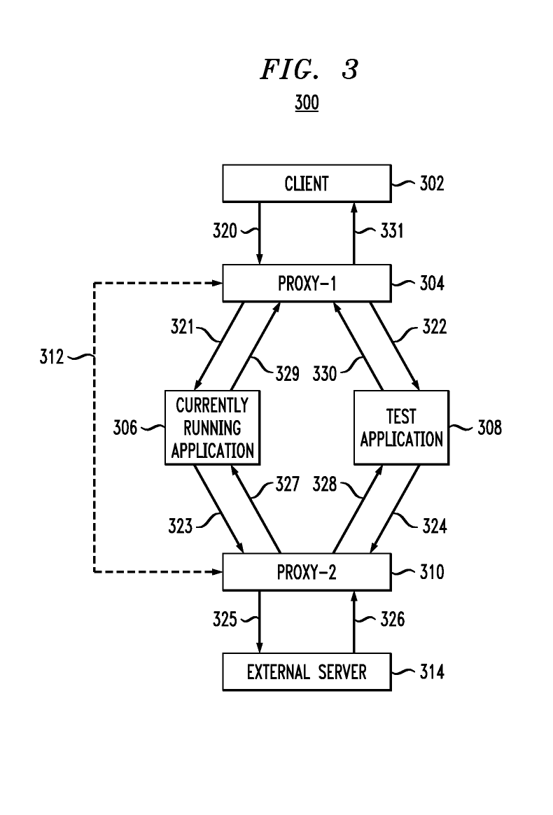

In situations where more than one proxy is used (as will be illustrated below with reference to FIG. 3), recording may be regulated by commands from or related to another proxy. For example, in complex application testing, a client may make a request to an application and the corresponding response may be directed to a third-party server. In this case, a second proxy is needed to intercept the response. In order to synchronize recording, multiple proxy may instruct one another when to record.

With regard to relation criteria, responses may be recorded according to a relationship between the responses of the running application and the test application. For example, if two responses generally contain the same information, but one response contains a different URL, the responses may be similar enough to be recorded for analysis. The opposite may also apply. If a response contains an expected difference in syntax or content, the relation criteria may instruct the proxy to ignore the response.

At step 108, the responses from the test applications are compared to the responses from the running application. The comparison is used to evaluate if the test applications are performing properly. The comparing step may be as simple as searching for identical responses from both the test application and the running application. The easiest way to do this is to match responses according to syntax and time. However, in more complex situations, response times from multiple applications (e.g., test applications and running applications) may differ. This may be caused by networking delays and/or expected or unexpected application processing delays.

In an illustrative embodiment, the comparing step may be optimized by using a developer defined or automatically defined time frame. The time frame is set using a response time of the running application as reference. The time frame defines a window of recorded responses in which the proxy searches for corresponding test application responses for comparison. For example, a request from a client may be forwarded to a currently running application and a test application at time(T)=5 seconds(sec). A response may be received from the currently running application at T=8 sec. At T=9 sec, assume that a status response is sent from the test application and recorded by the proxy. At T=10 sec, assume that an additional status response is sent from the test application and recorded by the proxy. Finally, at T=11 sec, a response to the initial request is received from the test application. It is to be understood that dozens if not hundreds of responses will be recorded and therefore, searching the entire record for corresponding responses is time consuming and inefficient. In this example, a time frame of ±3 sec may be appropriate for response searching. Therefore, the proxy may search the test application response record from T=5 sec to T=11 sec to find the test application response corresponding to the running application response received at T=8 sec. It is to be appreciated that this example is a simplification and is meant for ease of explanation. A person of ordinary skill in the art would readily recognize how to manipulate the time frame for optimizing the searching and comparing process.

In an additional embodiment, the searching process may be in accordance with a matching policy defined by a developer/tester. The matching policy may define if a response from a test application corresponds to a response from a running application. For instance, a developer may have programmed a test application to return a response that is different than a response from a currently running application. The difference may be a change in syntax or a change in content, such as a web address or other reference. In order to conduct a proper search, the matching policy may instruct the proxy to match responses which would not have been matched due to these differences.

It is to be appreciated that the recording step (106) and the comparing step (108) are not limited to recording and comparing responses. In an illustrative embodiment, a currently running application and a test application may send one or more requests to other clients and/or servers. These requests may also be recorded and compared for evaluation purposes. Further, the recorded requests may be evaluated together with the recorded responses.

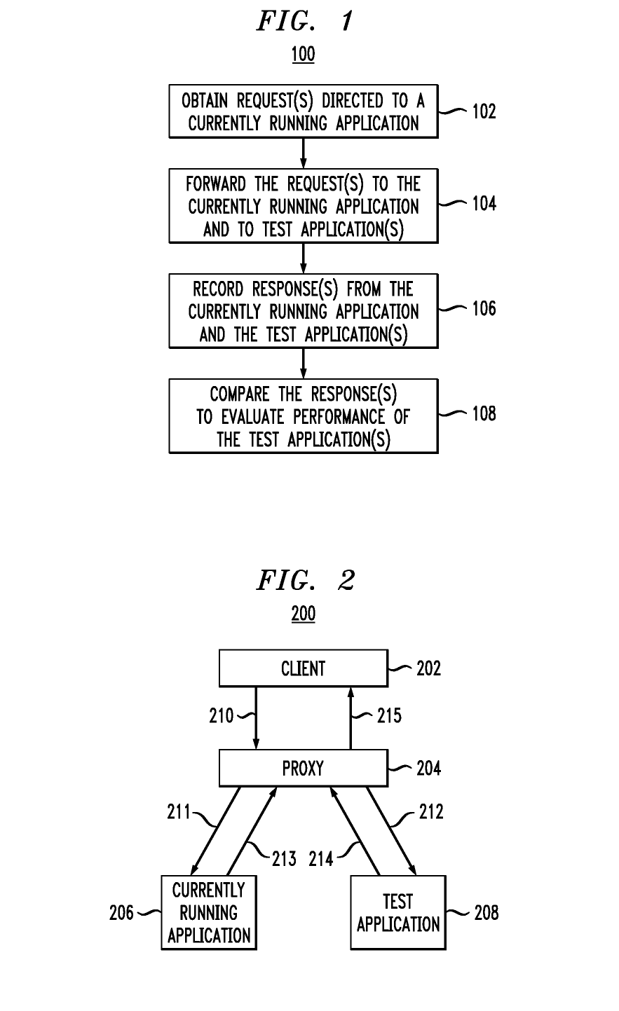

Referring now to FIG. 2, a diagram illustrates a system for testing applications using one proxy, in accordance with an embodiment of the present invention. The client 202 is connected to a proxy 204 via a communications network. In an illustrative embodiment, the client 202 may be a user and/or a server. The proxy 204 is also connected to a currently running application 206 and a test application 208. In an additional embodiment, the running application 206 may be a web application or a web application server. Furthermore, it is to be appreciated that the proxy 204 may be connected to multiple test applications and is not limited to one test application connection.

At flow 210, the proxy 204, which is networked between the client 202 and the running application 206, intercepts any requests from the client 202 to the running application 206. At flow 211, the proxy 204 forwards an intercepted request to the running application 206. At flow 212, the proxy 204 also forwards the same intercepted request to the test application 208. In response to the request, the currently running application 206 returns a response to the client (flow 213). Further, the test application 208 also returns a response to the client (flow 214). The proxy 204 then intercepts and records both responses. The recorded responses (213, 214) are then compared and the performance of the test application 208 is evaluated.

In an alternative embodiment, the proxy 204 forwards a response from the running application (213) to the client 202 (flow 215). By doing so, the client 202 can interact with the currently running application 206 normally and without interruption while the test application 208 is being tested. It should be noted that the test application 208 is tested as if the client were interacting directly with the test application 208. Therefore, the application is tested with real-world operations in real-time, and not with pre-generated test cases. Furthermore, even if the test application 208 fails, the client 202 and the currently running application 206 are unaffected.

Referring now to FIG. 3, a diagram illustrates a system for testing applications using two proxy, in accordance with an additional embodiment of the present invention. It is to be appreciated that more than two proxy may be used, however, only two proxy have been illustrated for ease of explanation. The system in FIG. 3 comprises a client 302 connected to a first proxy, proxy-1 304, via a communications network. Proxy-1 304 is connected to a currently running application 306 and a test application 308 also via a communications network. A second proxy, proxy-2 310, is connected to proxy-1 304, the currently running application 306, and the test application 308. Additionally, proxy-2 310 is also connected to an external server 314. This scenario illustrates a situation where a client interacts with an external server indirectly through a running application. For example, a bank customer may make a transaction through a web page of a bank, in turn, the bank may access third-party servers to carry out the transaction.

At flow 320, the client 302 sends a request to the currently running application 306, which is intercepted by proxy-1 304. At flows 321 and 322, proxy-1 304 forwards the request to the currently running application 306 and the test application 308, respectively. The request is processed by both applications (306 and 308) and responses, which are directed to external server 314, are generated. At flows 323 and 324, responses from the currently running application 306 and the test application 308, respectively, are intercepted and recorded by proxy-2 310. At flow 325, the response from the running application 306 is forwarded to the external server 314. At flow 326, the external server 314 generates and returns a response. The response is intercepted and recorded by proxy-2 310. Next, at flows 327 and 328, the response from the external server 314 is forwarded to the currently running application 306 and the test application 308, respectively. At flows 329 and 330, responses from the currently running application 306 and the test application 308 are intercepted and recorded by proxy-1 304. At flow 331, the response from the currently running application 306 is forwarded to the client 302, making the interaction between the client 302 and the currently running application 306 uninterrupted.

The recorded response data stored at proxy-1 304 and proxy-2 310 are analyzed and the performance of the test application 308 is evaluated. In an exemplary embodiment, proxy-1 304 and proxy-2 310 communicate instructions to each other via connection 312. This is necessary to synchronize the recording of responses during the testing session. For example, proxy-1 304 may alert proxy-2 310 of an expected response after forwarding a request, and vice versa.

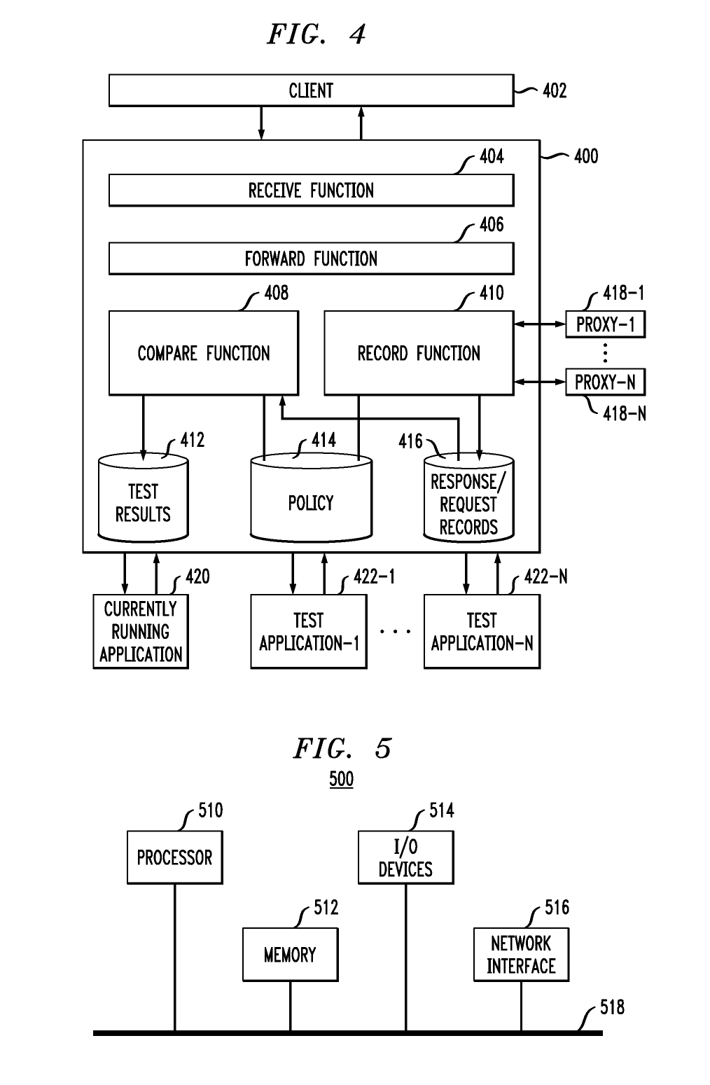

Referring now to FIG. 4, a system diagram illustrates the components of a proxy 400, in accordance with one embodiment of the present invention. The components of system 400 carry out the methods illustrated in FIG. 1. The receive function 404 carries out step 102 of FIG. 1. The receive function 404 is responsible for intercepting a request from a client 402 that is directed to a currently running application 420. The forward function 406 carries out step 104 of FIG. 1. The forward function 406 is responsible for forwarding requests to a client (e.g., 402), a server, a currently running application (e.g., 420), and/or multiple test applications (e.g., 422-1, . . . 422-N). The record function 410 carries out step 106 of FIG. 1. The record function 410 is responsible for recording responses and/or requests at a storage unit 416. The record function 410 may record responses and requests in accordance with stored policies at policy 414. Furthermore, the record function 410 may record in accordance with instructions from one or more additional proxy (418-1, . . . 418-N). The compare function 408 carries out step 108 of FIG. 1. The compare function 416 processes (e.g., search and compare) the response/request records 416 and evaluates the performance of one or more test applications. There are many ways to evaluate performance and those techniques will not be discussed herein. The results of the evaluation are stored at test results 412. In an additional embodiment, the compare function 408 may compare records according to a developer/tester defined policy stored at policy 414.

Referring now to FIG. 5, step diagram 500 illustrates an exemplary hardware implementation of a computing system in accordance with which one or more components/methodologies of the invention (e.g., components/methodologies described in the context of FIGS. 1-6) may be implemented, according to an embodiment of the present invention.

As shown, the techniques for testing at least one application using at least one proxy may be implemented in accordance with a processor 510, a memory 512, I/O devices 514, and a network interface 516, coupled via a computer bus 518 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Still further, the phrase “network interface” as used herein is intended to include, for example, one or more transceivers to permit the computer system to communicate with another computer system via an appropriate communications protocol.

Software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method for testing at least one application using at least one proxy, the method comprising the steps of:
obtaining at least one request directed to a running application from a client;
forwarding the at least one request to the running application and at least one test application;
recording at least one response from the running application and at least one response from the at least one test application; and
comparing the at least one response from the at least one test application to the at least one response from the running application to evaluate performance of the at least one test application.

2. The method of claim 1, wherein the client is at least one of a user or a server.

3. The method of claim 1, wherein the running application is a web application.

4. The method of claim 1, wherein the step of recording is in accordance with at least one of a recording policy, a client identification, a uniform resource locator, a content of the at least one response from the running application, a content of the at least one response from the at least one test application, an instruction from another proxy, and a relation criteria.

5. The method of claim 4, wherein the client identification is at least one of an internet protocol address, a hypertext transfer protocol session identification, and an authentication.

6. The method of claim 1, wherein the step of comparing further comprises the steps of:
setting a time frame in reference to the at least one response from the running application; and
searching, within the time frame, for the at least one response from the at least one test application corresponding to the at least one response from the running application.

7. The method of claim 6, wherein the step of searching is in accordance with a matching policy, wherein the matching policy determines if the at least one response from the at least one test application corresponds to the at least one response from the running application.

8. The method of claim 1, further comprising the step of forwarding the at least one response from the running application to the client.

9. The method of claim 1, further comprising the steps of:
recording at least one request from the running application and at least one request from the at least one test application, directed to a server; and
comparing the at least one request from the at least one test application to the at least one request from the running application to evaluate performance of the at least one test application.

10. The method of claim 9, further comprising the steps of:
forwarding the at least one request from the running application to the server;
obtaining at least one response from the server; and
forwarding the at least one response from the server to the running application and the at least one test application.

11. An article of manufacture for testing at least one application using at least one proxy, the article comprising a computer readable storage medium identified by one or more programs, which when executed by a computer implement the steps of claim 1.

12. An apparatus for testing at least one application using at least one proxy, the apparatus comprising:
a memory; and
at least one processor coupled to the memory and operative to: (i) obtain at least one request directed to a running application from a client; (ii) forward the at least one request to the running application and at least one test application; (iii) record at least one response from the running application and at least one response from the at least one test application; and (iv) compare the at least one response from the at least one test application to the at least one response from the running application to evaluate performance of the at least one test application.

13. The apparatus of claim 12, wherein the client is at least one of a user or a server.

14. The apparatus of claim 12, wherein the operation of recording is in accordance with at least one of a recording policy, a client identification, a uniform resource locator, a content of the at least one response from the running application, a content of the at least one response from the at least one test application, an instruction from another proxy, and a relation criteria.

15. The apparatus of claim 14, wherein the client identification is at least one of an internet protocol address, a hypertext transfer protocol session identification, and an authentication.

16. The apparatus of claim 12, wherein the processor is further operative to:
set a time frame in reference to the at least one response from the running application; and
search, within the time frame, for the at least one response from the at least one test application corresponding to the at least one response from the running application.

17. The apparatus of claim 16, wherein the operation of searching is in accordance with a matching policy, wherein the matching policy determines if the at least one response from the at least one test application corresponds to the at least one response from the running application.

18. The apparatus of claim 12, wherein the processor is further operative to forward the at least one response from the running application to the client.

19. The apparatus of claim 12, the processor further operative to:
record at least one request from the running application and at least one request from the at least one test application, directed to a server; and
compare the at least one request from the at least one test application to the at least one request from the running application to evaluate performance of the at least one test application.

20. A system for testing at least one application using at least one proxy, the system comprising:
a first server;
at least one second server connected to the first server via a communications network; and
at least one processor operatively coupled to the first server, the processor being operative to: (i) obtain at least one request directed to a running application from a server; (ii) forward the at least one request to the running application and at least one test application; (iii) record at least one response from the running application and at least one response from the at least one test application; and (iv) compare the at least one response from the at least one test application to the at least one response from the running application to evaluate performance of the at least one test application.

21. A system for testing at least one application using at least one proxy, the system comprising:
a first server;
a first proxy connected to the first server via a communications network;
at least one second server connected to the first proxy via a communications network;
a second proxy connected to the at least one second server via a communications network; and
a third server connected to the second proxy via a communications network,
wherein the first and second proxy are operative to: (i) obtain at least one request directed to a running application from a server; (ii) forward the at least one request to the running application and at least one test application; (iii) record at least one response from the running application and at least one response from the at least one test application; and (iv) compare the at least one response from the at least one test application to the at least one response from the running application to evaluate performance of the at least one test application.
